(19) United States
(12) Patent Application Publication
(10) Pub. No.: US 2010/0228477 A1
(43) Pub. Date: Sep. 9, 2010

(54) METHOD OF MAP ADDRESS DATA UPDATE

(75) Inventor: Naohiro Sakashita, Farmington Hills, MI (US)

Correspondence Address: HARNESS, DICKEY & PIERCE, P.L.C., P.O. BOX 828, BLOOMFIELD HILLS, MI, 48303, US

(73) Assignees: DENSO International America, Inc., Southfield, MI (US); DENSO Corporation, Aichi-ken (JP)

(21) Appl. No.: 12/399,432

(22) Filed: Mar. 6, 2009

(51) Int. Cl. G01C 21/36

(52) U.S. Cl. 701/209

(57) ABSTRACT

A method of updating map address data in a navigation system by first determining when the navigation system has used a destination address number that was input by a driver to calculate the route to the destination address, then determining when an engine of a vehicle has been shut off after the navigation system was used to calculate a route to the destination address. Next, the navigation system determines whether the vehicle is within a predetermined range from the map address stored in a memory of the navigation system. If so, the navigation system learns the address that is the closest to the location where the vehicle was shut off and the navigation system adjusts the map address in memory based on the address that is closest to the location where the vehicle was shut off.

### FIELD

The present disclosure relates to navigation systems generally, and more particularly, to updating navigation system map data.

### BACKGROUND

This section provides background information related to the present disclosure which is not necessarily prior art. Navigation systems typically use an address entered by a human user as a destination location that is displayed on a navigation system screen. However, the address data stored in the map data of the navigation system and the actual, physical street address may not correspond because the address data is calculated based on the addresses at the ends of the road. When the actual address and the address data do not correspond, the driver arrives at the incorrect destination point, which is undesirable.

### SUMMARY

This section provides a general summary of the disclosure, and is not a comprehensive disclosure of its full scope or all of its features. A first method of updating map address data in a navigation system is performed by first determining when the navigation system has used a destination address (e.g. a number address) that was input by a vehicle driver to calculate a route to the destination address and then determining when (a length of time) an engine of a vehicle has been shut off after the navigation system was used to calculate a route to the destination address. Next, the navigation system determines whether the vehicle is within a predetermined range (e.g. a distance range) from the map address stored in a memory of the navigation system. If the vehicle is within a predetermined distance range, the navigation system learns the address that is the closest to the location where the vehicle was shut off and the navigation system adjusts the map address in memory based on the address that is closest to the location where the vehicle was shut off.

A second method of updating map address data in a navigation system is performed by first determining when the navigation system has used a destination address number that was input by a driver to calculate the route to the destination address, then determining when an engine of a vehicle has been shut off after the navigation system was used to calculate a route to the destination address. Next, the navigation system determines whether the vehicle is within a predetermined range or distance from the map address stored in a memory of the navigation system. If so, the navigation system learns the address that is the closest to the location where the vehicle was shut off and the navigation system adjusts the map address in memory based on the address that is closest to the location where the vehicle was shut off. Lastly, the navigation system determines a destination route based on the adjusted map address.

A third method of updating map address data in a navigation system is performed by first determining when the navigation system has used a destination address number that was input by a driver to calculate the route to the destination address, then determining when an engine of a vehicle has been shut off after the navigation system was used to calculate a route to the destination address. Next, the navigation system determines whether the vehicle is within a predetermined range from the map address stored in a memory of the navigation system. If so, the navigation system learns the address that is the closest to the location where the vehicle was shut off and the navigation system adjusts the map address in memory based on the address that is closest to the location where the vehicle was shut off and a pair of map addresses representing a beginning address and an ending address of a portion of a road where the actual address is located. Lastly, the navigation system determines a destination route based on the adjusted map address.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a plan view of a road grid depicting the difference between actual, physical address locations and map address data locations;

FIG. 2 is a navigation route depicting a vehicle arriving at a desired address based on a driver's intervention in accordance with the present teachings;

FIG. 3 is a plan view of a road depicting the map data being corrected to correspond to the actual address location where the vehicle arrived in accordance with the present teachings;

FIG. 4 is a flow chart depicting steps performed after a driver and vehicle arrive at a destination in accordance with the present teachings;

FIG. 5 is a flow chart depicting steps performed to update address data in accordance with the present teachings;

FIG. 6 is a flow chart depicting steps used to determine route calculation in accordance with the present teachings; and

FIG. 7 is a perspective view of an interior of a vehicle depicting the location of a navigation system.

Corresponding reference numerals indicate corresponding parts throughout the several views of the drawings.

### DETAILED DESCRIPTION

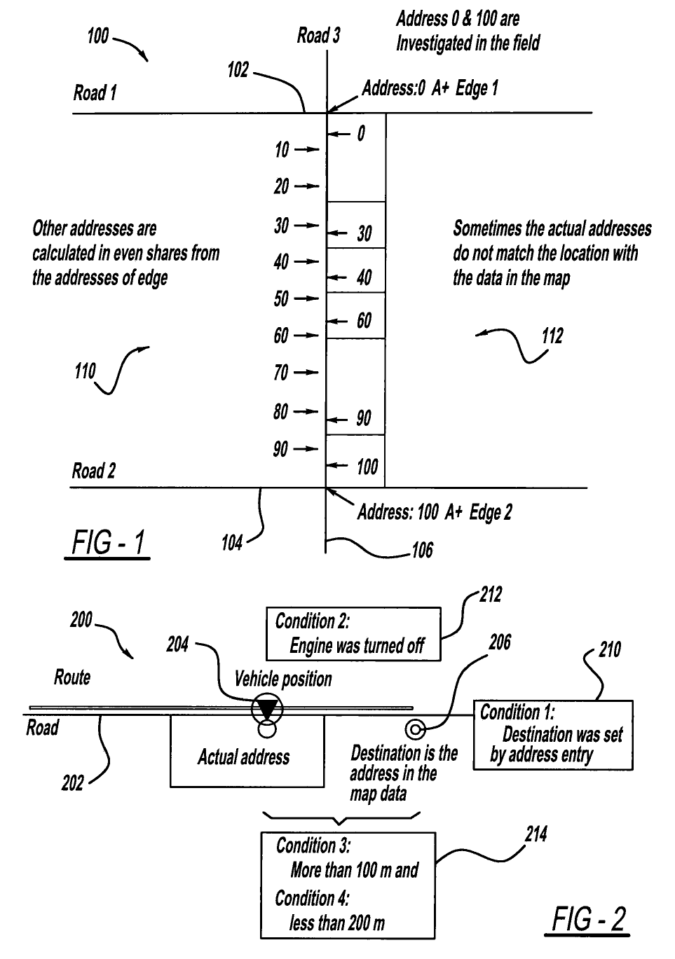

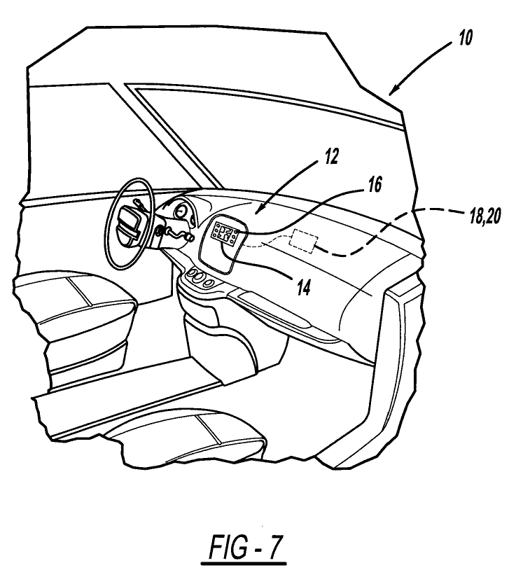

Example embodiments will now be described more fully with reference to FIGS. 1-7 of the accompanying drawings. FIG. 1 is a plan view of an adjoining road grid 100 depicting the difference between actual address locations and map address data locations. Actual address locations are the physical, geographical ground locations that correspond to numerical addresses while map address data locations are the locations stored in map data in a memory 18 (FIG. 7), such as in a navigation system 12 utilized within a vehicle 10. In order to determine map address data locations, a pair of map addresses corresponding to adjacent road ends, also called road edges 102 and 104 that intersect a single road 106 are utilized. After the pair of map addresses is determined, each address along road 106 is placed at equally space distances between the pair of map addresses. Each of these map addresses are illustrated as part of a grid 110. However, the geographical or actual address locations, which are shown in a grid 112 are often different than those stored in memory, as depicted in the grid 110, which may cause a driver to arrive at an incorrect location.

As a visual example, a map address location 30 in the grid 110 does not align with the actual address location 30 in the grid 112. Stated slightly differently, if a vehicle driver enters a location, such as a numerical address, into an interface 16 of a vehicle navigation system 12 as the desired address location 30 to travel to, the navigation system would arrive at an incorrect location along the road 106. That is, the incorrect location is an address in the map data in the navigation system, in a memory for example, that will not display the correct physical address or location, but rather direct the driver to an incorrect address that is different from the correct physical address. As can be seen in FIG. 1, other actual and stored address locations, such as locations ranging from 0-100, do not align.

With reference to FIG. 2, a navigation route 200 depicts a vehicle arriving along a road 202 at a correct location 204 based on a driver's intervention. Here, the driver has realized that a destination point 206 provided by the map data of the navigation system is not correct. As such, the driver recognized the correct address at the correct location 204 for which he or she was looking and has ignored information provided by the navigation system, which has provided an incorrect location. On the screen 14 or display of the navigation system 12 in the vehicle 10, the incorrect location 206 is displayed further along the road 202 from the actual, correct location 204, to which the driver desired to travel. Continuing with FIG. 2, because of the above-explained scenario, a series of steps or questions are asked by the navigation system. For instance, in step 210, navigation system control determines if the destination was set using an address entry (Condition 1), such as a physical address entry entered into a navigation screen or keypad display by a vehicle driver. If so, control continues to step 212 where control determines if the engine was turned off when the vehicle arrived at the desired location (Condition 2), which is the actual and correct physical location 204 of the address. If so, control continues to step 214 and determines whether the difference in distance between the desired location and the incorrect address location is greater than 100 meters (Condition 3) and less than 200 meters (Condition 4). The 100 meter requirement prevents the map data from being adjusted when the distance is not great enough to cause the driver to arrive at the wrong location. In other words, if the map data in the navigation system can direct a vehicle driver to 100 meters or less from the actual and correct address, then there may be no need for adjustment or correction of the map data in the navigation system. The 200 meter distance requirement prevents map data adjustment when a driver has stopped in route to the destination address but at a distance that is greater than 200 meters from the destination address. Such might occur if a driver stops at a gas station, for example. When control determines that all of the conditions are met, the map data is corrected to correspond to the desired address location.

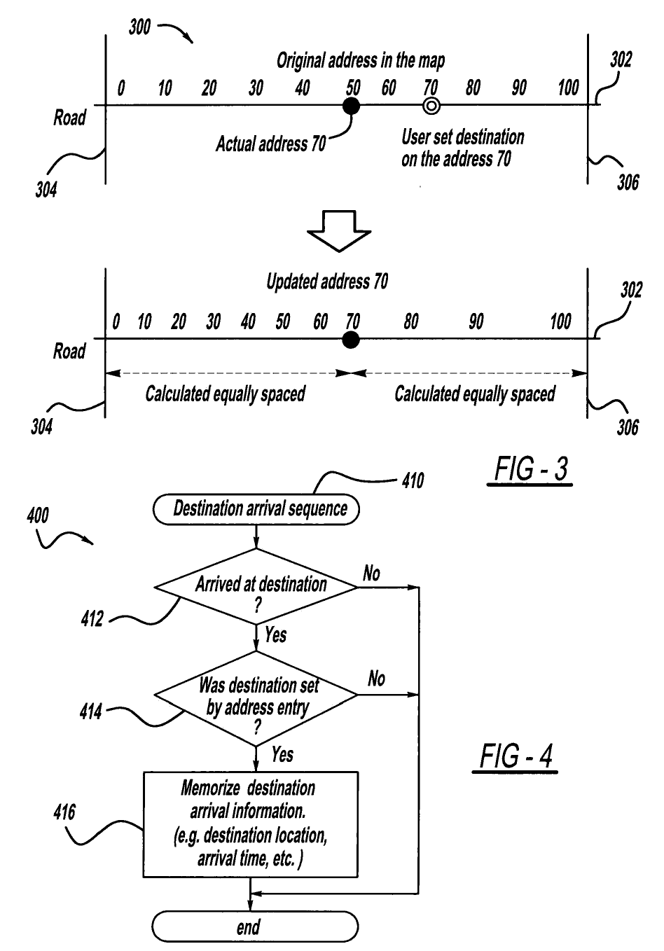

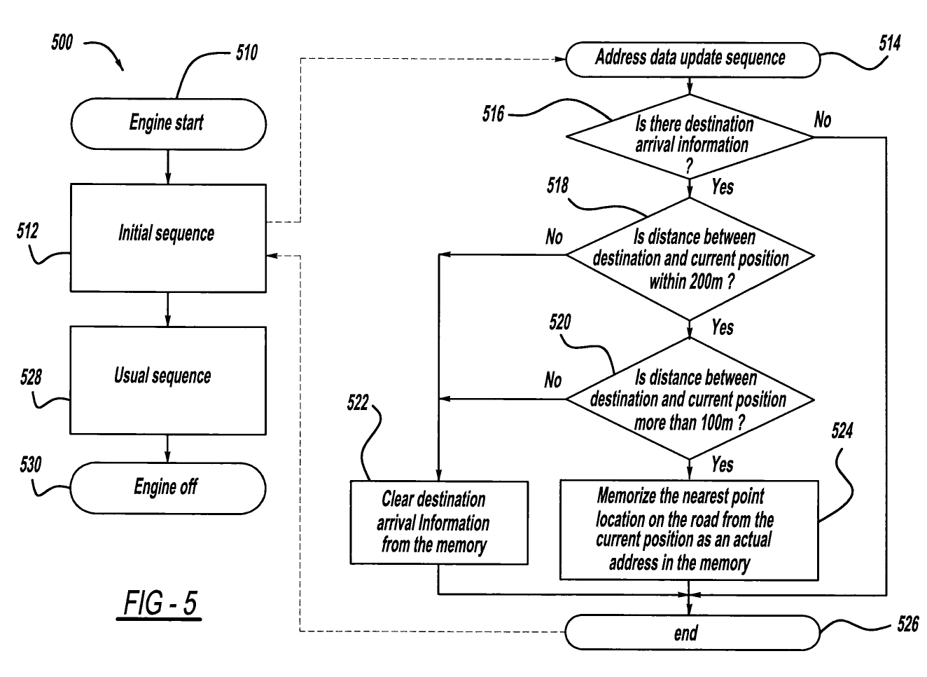

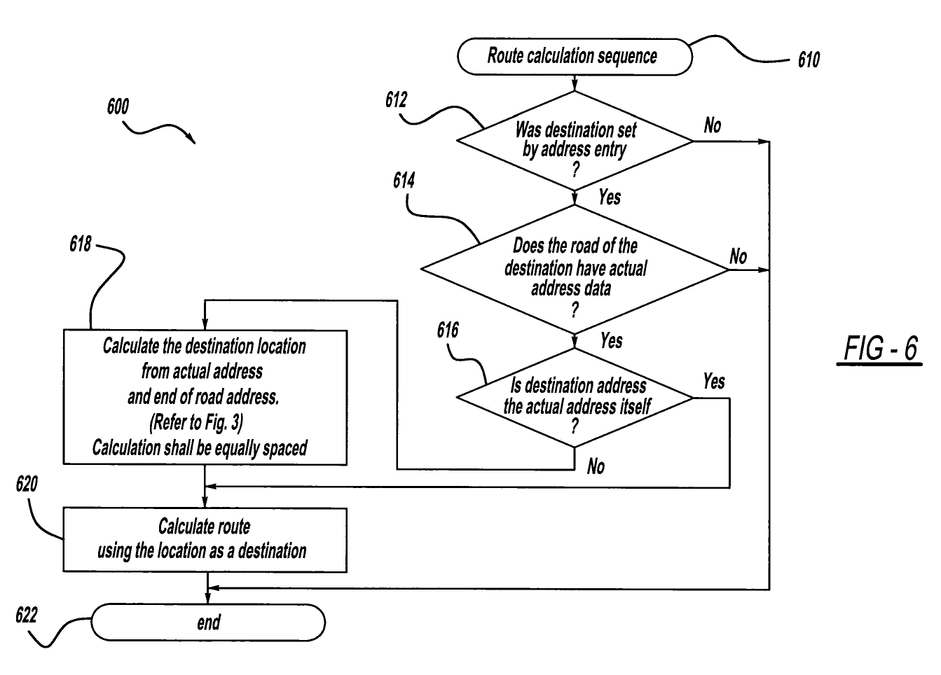

With reference to FIG. 3, a plan view of a road is shown, which depicts a map system 300 being updated to correspond to the actual address location where a vehicle arrived. For example, the address the driver desired is located along a road 302, with a cross-road 302 at one end, and a cross road 304 at the opposite end of road 302. However, an actual address number 70 that the driver desired is located near an address number 50 of the original map data. The correct destination point is actually further along or down the road 302 near or at the map data address number 50. The navigation system may then adjust the map data so that the incorrect destination is changed to the actual address location where the vehicle arrived. In other words, the map data is updated to reflect the actual address location so that the map data is correct. The adjustment is accomplished by moving the incorrect destination point, as displayed on the screen according to the map data, to the actual address location where the vehicle arrived. The navigation system then evenly spaces, by recalculation and updating, each of the other addresses between adjacent roads 304 and 306 to provide a more accurate estimate of each of the address locations. One will notice how the locations 0-100 on the road labeled “Updated address 70” are updated and evenly spaced on either side of location 70, after recalculation.

With reference to FIG. 4, a flow chart 400 depicts steps performed after a driver arrives at a desired destination. In step 410, control initiates a destination arrival sequence and in step 412, control determines whether the vehicle arrived at the desired destination. If the vehicle arrived at the desired destination, control continues to step 414, and if not, control ends. In step 414, control determines whether the destination location was set by an address entry, such as by a driver of a vehicle entering the address into the navigation system. If so, control continues in step 416, and if not, control ends. In step 416, control stores or memorizes the destination arrival address as depicted in FIG. 3 and subsequently, control ends. Causing or storing the destination arrival address may be initiated by a user pressing or touching a user interface 16 (FIG. 7) of the navigation system in response to a screen prompt.

With reference to FIG. 5, a flow chart 500 depicts steps performed to update map address data. In step 510, engine starting or operation begins, and in step 512, control determines an initial sequence, which may be a series of additional steps. In step 514, control begins an address data update sequence which then proceeds to step 516, where control determines if there is destination arrival information based on the actual vehicle position. If so, control continues to step 518, and if not, control ends. In step 518, control determines whether the difference between the actual address location and the current vehicle location is less than 200 meters. If so, control continues in step 520, and if not, control transfers to step 522 where the destination arrival information is cleared from memory. In step 520, control determines if the distance between the actual address location and the current vehicle location is greater than 100 meters. If so, control continues to step 524, and if not, control transfers to step 522 where the destination arrival information is cleared from memory. In step 524, control memorizes, or stores in memory, the nearest point location on the road from the current vehicle location. The nearest point location on the road then becomes the actual (corrected) address location. In step 526, the address data update sequence, which began at step 514, ends and then control transfers back to step 512. Control continues in step 528 and performs a usual sequence, such as a normal navigation system routine, as may be known in the art. In step 530, control ends when the engine is shut off.

With reference to FIG. 6, a flow chart 600 depicts steps used to determine route calculation. In step 610, control initiates a route calculation sequence and then proceeds to step 612 where control determines whether the destination location was set by an address entry, such as by a person entering an address into a vehicle navigation system. If the destination was set by an address entry, control continues to 614, and if not, control ends. In step 614, control determines whether the destination road has actual address data, and if so, control continues to step 616 and if not, control ends at step 622. In step 616, control determines whether the destination address is the actual address itself, and if not, control continues to step 618, and if so, control continues to step 620. In step 618, control calculates the destination based on the actual address, equally spaced from the end of the road at address 100, as depicted in FIG. 3. In step 620, control calculates a route using the updated location as a destination. In step 622, control ends.

FIG. 7 depicts a vehicle 10, within which a navigation system 12 may reside. The navigation system 12 may have a display 14 to display the various routes a user may follow to a destination, as discussed above, and a user interface 16, which may include a keypad and/or a keyboard to enter in the numerical numbers and names that correspond to a street address to which a driver may desire to travel. The navigation system 12 may be equipped with a memory location 18 to store the map data and addresses that a user may enter via the user interface 16. Additionally, the vehicle may employ a global positioning system (GPS) 20 to aid in determining actual vehicle locations along a roadway, such as at an actual address.

The methods of the present disclosure may include updating map address information, for example, when the map data of the navigation system 12 directs a vehicle to between 100 and 200 meters (inclusive) from an actual street address. There may be at least one situation in which the map address data should not be updated when the vehicle is within the 100-200 range. The situation is when the actual address is a large physical geographical area, such as a park or shopping center and the parking area, for example, is part of the address. More specifically, as an example, if a driver enters a parking area of a shopping mall, he or she may have to park between 100 and 200 meters from the indoor entrance to the shopping area or store. In such a situation, the driver knows that he or she is at the desired, actual address and may not want the navigation system map address information to be updated. The navigation screen may prompt a driver with the option of updating the map address information or not updating the map address information.

The method of the above teachings may be presented slightly differently. As such, a method of updating a map address or map address data in a navigation system may entail determining when or if the navigation system utilized a destination address number input by a driver to calculate a route to a destination address, determining when an engine of a vehicle has been shut off after the navigation system was used to calculate a route to the destination address, determining whether the vehicle is within a predetermined range from the geographical location of the map address that is stored in a memory of the navigation system, learning the address that is the closest to the location where the vehicle was shut off, and adjusting the map address in memory based on the address that is closest to the location where the vehicle was shut off.

The method may further employ adjusting the map address to become an adjusted map address based on a pair of map addresses such as a first address of the pair representing a beginning address and a second address of the pair representing an ending address. The actual address may be located between the pair of map addresses yet along the same road. The method may then further entail adjusting each of a plurality of address locations in memory 18 that are between the beginning address and the adjusted map address at equally spaced intervals. In other words, the distance between each address along a road will be adjusted to be equal and then stored in memory. The same equal distance adjustment may be made for each of a plurality of address locations that are between the ending address and the adjusted map address. A lower limit of the predetermined range may be about 100 meters while an upper limit of the predetermined range may be about 200 meters. Moreover, the map address may be prevented from being corrected when the upper limit is within the predetermined range, such as when the vehicle has been shut off before arriving at the desired location.

Moreover, a method of updating a map address and determining a route using a navigation system of a vehicle may employ entering a driver-entered address number in the navigation system for a desired address, which may be an address to which a driver desires to travel. Next, the method may entail calculating a route to the driver-entered address number by utilizing a map address location from the navigation system memory. The method may then involve determining when and where an engine of a vehicle has been shut off after calculating a route to the driver-entered address number from a map-address location in navigation memory.

After the engine is turned off, the method may continue by determining whether the vehicle is geographically within a predetermined distance range from the map address location stored in the memory of the navigation system, learning the actual address that is closest to the location where the vehicle was turned off and then adjusting the map address in memory with a map address based on the actual address that is closest to the location where the vehicle was turned off. Still yet, the method may proceed by determining a destination route based on the adjusted map address and adjusting the map address in memory to an adjusted map address based on a first map address representing a beginning address and a second map address representing an ending address such that the first and second map addresses are located along a portion of the same road with the actual address located between the first and second map addresses. The interval or distance between each address may be calculated such that they are equal. Alternatively, adjusting the map address in memory may be accomplished by using the actual address where the vehicle was shut off and a first road end address and a second road end address of a road along which the actual address is located. More specifically, the interval between the address locations in the map address data may be even between the location where the vehicle was shut off and the first road end address. Similarly, the interval between the address locations in the map address data may be even between the location where the vehicle was shut off and the second road end address. The interval or distance between each address on each side of where the vehicle was shut off through to the end of the road on each side of the vehicle may be a different interval.

The method steps, processes, and operations described herein are not to be construed as necessarily requiring their performance in the particular order discussed or illustrated, however, the method may be restricted to the order of their above presentation. It is also to be understood that additional or alternative steps may be employed. Steps involving updating may include a driver touching the user interface 16 such as to select a location (address) along a road. The user interface 16 may include a touch-screen display to select an input, buttons to depress, such as with a keyboard or keypad.

The foregoing description of the embodiments has been provided for purposes of illustration and description. It is not intended to be exhaustive or to limit the invention. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the invention, and all such modifications are intended to be included within the scope of the invention.

What is claimed is:

1. A method of updating a map address of map address data in a navigation system, the method comprising:
determining when the navigation system used a destination address number input by a driver to calculate a route to a destination address;
determining when an engine of a vehicle has been shut off after the navigation system was used to calculate a route to the destination address;
determining whether the vehicle is within a predetermined range from the map address that is stored in a memory of the navigation system;
learning the address that is the closest to the location where the vehicle was shut off; and
adjusting the map address in memory based on the address that is closest to the location where the vehicle was shut off.

2. The method of claim 1, wherein adjusting the map address further comprising:
adjusting the map address to become an adjusted map address based on a pair of map addresses, a first address of the pair representing a beginning address and a second address of the pair representing an ending address, the actual address located between the pair of map addresses and along a portion of a same road.

3. The method of claim 2, further comprising:
adjusting each of a plurality of address locations in memory that are between the beginning address and the adjusted map address at equally spaced intervals.

4. The system of claim 2, further comprising:
adjusting each of a plurality of address locations that are between the ending address and the adjusted map address at equally spaced intervals.

5. The method of claim 4, wherein the plurality of address locations in memory that are between the beginning address and the adjusted map address, and the plurality of address locations that are between the ending address and the adjusted map address are adjusted at equally spaced distances.

6. The method of claim 1, wherein a lower limit of the predetermined range is about 100 meters.

7. The method of claim 6, wherein an upper limit of the predetermined range is about 200 meters.

8. The method of claim 7, further comprising:
preventing the map address from being corrected when the upper limit is within the predetermined range, when the vehicle has been shut off and before arriving at the desired location.

9. A method of updating a map address and determining a route using a navigation system of a vehicle, the method comprising:
entering a driver-entered address number in the navigation system for a desired address;
calculating a route to the driver-entered address number from a map address location in navigation memory;
determining when an engine of a vehicle has been shut off after calculating a route to the driver-entered address number from a map-address location in navigation memory;
memorizing a location where the vehicle was turned off;
determining whether the vehicle is geographically within a predetermined distance range from the map address location stored in a memory of the navigation system;
learning the actual address that is closest to the location where the vehicle was turned off;
adjusting the map address in memory with a map address based on the actual address that is closest to the location where the vehicle was turned off; and
determining a destination route based on the adjusted map address.

10. The method of claim 9 wherein adjusting the map address further comprises:
adjusting the map address in memory to an adjusted map address based on a first map addresses representing a beginning address and a second map address representing an ending address, the first and second map addresses located along a portion of a road, the actual address located between the first and second map addresses.

11. The method of claim 10, further comprising:
adjusting a location of each of a plurality of address locations in the map data that are between the beginning address and the adjusted map address at equal intervals.

12. The method of claim 10, further comprising:
adjusting a location of each of a plurality of address locations that are between the ending address and the adjusted map address at equal intervals.

13. The method of claim 9, wherein the predetermined distance range includes from 100 meters up to and including 200 meters.

14. The method of claim 9, wherein an upper limit of the predetermined distance range is 200 meters.

15. The method of claim 14, further comprising:
preventing the navigation system from correcting the map address when the vehicle has been shut off before arriving at the desired location and the vehicle is farther than the upper limit from the map address location stored in a memory of the navigation system.

16. A method of updating map address data in a navigation system of a vehicle, the method comprising:
entering an address number using a driver interface of the navigation system;
calculating a route to a desired address that correlates to the address number;
shutting off an engine of the vehicle after calculating a route to the desired address;
determining whether the vehicle is within a predetermined range of distance from a location corresponding to the map address stored in a memory of the navigation system;
learning an actual address nearest to the location where the vehicle was shut off;
adjusting the map address in memory using an adjusted map address using the actual address where the vehicle was shut off and a first road end address and a second road end address of a road along which the actual address is located; and
determining a destination route based on the adjusted map address.

17. The method of claim 16, further comprising:
adjusting a location of each of a plurality of addresses in the map address that are between the first road end address and the adjusted map address to equal intervals.

18. The method of claim 17, further comprising:
adjusting the location of each of a plurality of addresses in the map address that are between the second road end address and the adjusted map address to equal intervals.

19. The method of claim 16, wherein:
a lower limit of the predetermined range of distance is 100 meters; and
an upper limit of the predetermined range of distance is 200 meters.
